(19) United States
(12) Patent Application Publication
(10) Pub. No.: US 2003/0166777 A1
(43) Pub. Date: Sep. 4, 2003

(54) Continuous phase silicone blends

(76) Inventor: David J. Vachon, Granada Hills, CA (US)

Correspondence Address: Mary Louise Gioeni, Heslin Rothenberg Farley & Mesiti P.C., 5 Columbia Circle, Albany, NY, 12203, US

(21) Appl. No.: 10/073,557

(22) Filed: Feb. 11, 2002

(51) Int. Cl. C08L 83/00

(52) U.S. Cl. 525/100

(57) ABSTRACT

Excellent physical and chemical properties are achieved from cured blends of silicone polymer with organic polymers, without the use of a compatibilizer. The silicone polymer may be a high molecular weight silicone (gum) polymer or a lower molecular weight silicone polymer (LSR) formulated with a catalyst for heat cure, or a silicone polymer designed as a moisture curing Room Temperature Vulcanizing (RTV) formulation. The organic polymer may be derived from a monoolefin or from a conjugated diolefin monomer, vinyl-substituted aromatic monomer such as styrene may also be included.

### FIELD OF THE INVENTION

The invention relates to silicone polymer/organic polymer blend compositions.

### BACKGROUND OF THE INVENTION

Polymeric materials exhibit a wide variety of chemical and physical characteristics. It is often the case that a polymer has excellent physical, and/or chemical properties in one area and has poor physical and/or chemical properties in another. As an example of this consider silicone rubber. While silicone rubber has excellent elasticity, softness, and oxidative stability, it has poor abrasion, minimal solvent resistance, and sub-par mechanical properties when compared to many organic polymers.

With respect to organic polymers, styrene-containing elastomers such as the Kraton product family (formerly Shell Chemical, now Kraton Polymers) have, in general, good properties, such as elasticity, flexibility, toughness and oxidative stability. Many of these materials are based upon styrene-diene copolymers, including those in which the residual unsaturation (in the diene component) have been hydrogenated to yield ethylene-butylene or ethylene-propylene (saturated) groups. These materials have excellent weathering resistance and heat resistance resulting from the very low content of, or even absence of, unsaturated linkages in their molecular structure, as well as excellent dielectric properties as a synthetic rubber. Demands and uses of elastomers with similar properties have rapidly grown in recent years considering, in addition, the economical advantages in costs, compared to other synthetic rubbers. However, many of these hydrogenated styrene-diene containing polymers are not processable by extrusion, injection molding or transfer molding because of high melt viscosity. As such, hydrogenated styrene-diene copolymers are typically used as additives to asphalt and other compositions or they are processed as solutions or by press molding.

It would seem that a simple solution would be to mechanically blend different polymers together, each having complementary physical property profiles, so that the resultant polymer blend would exhibit the superior physical properties of each component in the blend. However, the reality of the situation is that such polymer blends usually exhibit inferior physical properties. One reason for this is the fact that polymers may not be soluble/miscible with one another resulting in separate regions/spaces occupied by each polymer. Such mixtures/blends are said to be phase segregated/separated. In addition, polymers may have different curing mechanisms. That is, whether the polymer crosslinks by hydrosilation, condensation, or free radical initiation etc., will determine the rate at which the polymer will vulcanize to final cure. If two or more dissimilar polymers are present, and each of them cures independently of the others the result will be regions where the polymer blend is rich in one polymer and deficient in the other polymer(s). On the other hand, it is possible that only one of the polymers undergoes curing in the final processing, again resulting in an elastomer blend that is rich in one polymer and deficient in another.

U.S. Pat. No. 4,992,512 to Ward discloses silicone rubber blends with organic polymers. A separate compatibilizer adapts the curing mechanism of one of the polymers so that all components of the composition cure by the same type of mechanism in order to avoid phase separation. The silicone rubber components contains vinyl and/or hydride groups. Examples of these are silicone high consistency rubbers (HCR), silicone liquid rubbers (LCR), including liquid injection molding (LIM) silicone rubber and fluorosilicone rubbers. The organic polymer component contains hydroxy, alkoxy, carboxy, carboxyl, ester, amide, or halogen functional groups, which cure by a condensation mechanism. An ethylene/acrylate elastomer was used in the blends disclosed. The compatibilizer was a polyfunctional compound having an unsaturated ethylene functional group, a group selected from hydroxy, alkoxy, carboxy, ester, amide, and halogen in order to achieve a blend having acceptable physical properties. It reportedly functions by modifying the curing reaction in one of the polymers in order that both components of the blend cure by the same mechanism. Blends of materials that contain the same type of functionality are not described. Likewise, blends of a curable component and a component which contains very little or no functionality that can't react in a curing step are not disclosed. Finally, blends that do not contain a compatibilizer are not described.

There is, therefore, a continuing need for polymer blends having a desirable balance of physical and chemical properties. In particular, there is a need for silicone rubbers having improved abrasion resistance, tear resistance, tensile strength and compression set, while maintaining excellent elasticity, softness, and oxidative stability, in addition to excellent processability, chemical resistance, excellent mold releasability, and improved surface characteristics that include tactility and lubricity. This need may be met by silicone-organic polymer blends. More particularly, there is a need for silicone polymer blends with organic polymers that do not require the addition of a compatibilizer to achieve excellent physical and chemical properties.

### SUMMARY OF THE INVENTION

It has been unexpectedly discovered that novel and improved silicone elastomer blend compositions described herein have excellent mechanical, electric and tactile (touch) properties, lubricity, mold releasability, oxidative stability, and low tack (non-blocking behavior).

Accordingly, the invention relates, in one aspect, to a silicone polymer composition formulated with an organic polymer prior to vulcanization, the blend having excellent physical and chemical properties after vulcanization. The blend composition includes at least one silicone polymer and at least one organic polymer comprising residues derived from at least one olefin monomer. It does not include a compatibilizer that functions by modifying the curing reaction in one of the polymers in order that both components of the blend cure by the same mechanism. Specifically, the blend composition does not include a polyfunctional compatibilizer having an ethylenically unsaturated functional group and a group selected from hydroxy, alkoxy, carboxy, ester, amide, and halogen.

The organic polymer may include residues derived from at least one monoolefin monomer, or from at least one conjugated diolefin monomer, and may additionally include residues derived from at least one vinyl-substituted aromatic monomer, in particular, styrene. Preferred organic polymers include styrene butadiene rubbers (SBR), styrene ethylene random copolymers, styrene-isoprene-styrene block copolymers (SIPS), and hydrogenated styrene-butadiene-styrene block copolymers (SEBS). The silicone polymer may be in the form of a silicone gum, particularly a vinyl-functional silicone, or an acetoxy-functional silicone that cures by way of moisture induction.

It is an object of this invention to provide polysiloxane-organic polymer (blend) compositions comprising two or more polymers having chemical structure that render them compatible with silicone rubber. The organic polymer component may have chemical constituents/moieties, as part of the backbone, that provides the possibility of reactive blends to be produced. As an example, an unsaturated carbon-carbon bond in the backbone of a poly (styrene-butadiene) polymer could react with a vinyl group attached to a silicon atom of a polysiloxane thus providing a means for (partially) compatibilizing (or improving the compatibilization of the resultant blend.

Once the silicone-organic polymer blend has been vulcanized into a final configuration, the organic styrene-containing polymer that is at the surface may be chemically modified by a subsequent chemical reaction such as sulfonation or the like.

In another aspect, the invention relates to articles that include a cured polymer blend composition as described in the specification.

### DETAILED DESCRIPTION OF THE INVENTION

The present invention relates to a blend composition comprising at least one silicone polymer and at least one organic polymer. The composition does not include a compound or composition to increase compatibility between the components of the blend, and, in particular, does not include a polyfunctional compatibilizer having an ethylenically unsaturated functional group, and a group selected from hydroxy, alkoxy, carboxy, ester, amide, and halogen. The silicone polymer does not contain functional groups (other than vinyl groups) to react with the organic polymer.

The silicone polymer (prevulcanized) component of the blend composition of the present invention may have relatively high average molecular weight giving the polymer a gum-like consistency. Such silicones are commercially available as gums, filler-reinforced gums, dispersions, and uncatalyzed and ready-to-use catalyzed mixtures. The following types of gums are commercially available:

1) General purpose gums based on methyl and vinyl gums;

2) high and low temperature gums based on vinyl, phenyl, and methyl gums (including, for example, vinyl-functional poly(dimethylsiloxanes), poly(aryl)/(polyphenyl)siloxanes and mixed poly(dimethyldiphenyl)siloxane derivatives);

3) low compression set gums based on methyl and vinyl gums,

4) low shrink gums, i.e. gums which have been devolatilized, and

5) solvent resistant gums, based on fluorosilicone gums.

Suppliers of such materials include Nusil Technologies, General Electric, and Dow Corning.

The consistency of uncured silicone rubber mixtures ranges from a tough putty to a hard deformable plastic. Those rubbers containing reinforcing fillers tend to stiffen on storage due to the development of polymer-filler interactions. Low viscosity fluids added to the rubber, such as water, diphenylsilanediol, or silicone fluids may reduce/inhibit stiffening of the formulation by reducing the extent of polymer-filler interaction. The properties of fabricated silicone depend not only on the chemical nature of the gum but also on the properties of the filler, additives, and type of curing catalyst. Consequently, the property profile of a given heat cured silicone rubber is highly dependent on the chemical nature of the various constituent components as well as the relative proportions of those components. For example, a high filler content may increase hardness and solvent resistance of the resulting rubber. Such increased hardness and solvent resistance however, comes at the price of a reduced elongation.

Silicone polymers containing vinyl groups may be cured by one of three general curing techniques:

1) Hydrosilylation;

2) Free radical initiation; and

3) High energy radiation initiation.

For a hydrosilation cure, high molecular weight polymers, i.e. gums, possessing vinyl functionalities are reacted with low molecular weight hydride-functional cross-linking agents. A stable platinum complex typically functions as a catalyst. An inhibitor is typically added to minimize cure initiation prior to heating. A large variety of inhibitor compounds have been used; examples include alkaline earth metal silicates (U.S. Pat. No. 3,817,910), metal sulfides (U.S. Pat. No. 5,219,922), boron compounds (U.S. Pat. No. 4,690,967), and various organic compounds (U.S. Pat. No. 5,153,244) that include acetylenic alcohols such as ethynyl cyclohexanol or 2-methyl-3-butyn-2-ol (U.S. Pat. No. 5,248,715).

Free radical curing of silicone heat cured rubbers is effected by heating the rubber precursor in the presence of a free radical initiator/catalyst such as benzoyl peroxide. The predominant operating mechanism involves hydrogen abstraction from the methyl groups of the dimethylsiloxane moiety followed by radical attack on another methyl group creating a cross-linking ethyl bridge. If a small percentage of vinyl groups are present, the methyl radical can add to the vinylic double bond thus creating a propyl bridge. In addition to benzoyl peroxide, other radical cure initiators include bis (2,4-dichlorobenzoyl) peroxide, tert-butyl peroxybenzoate, dicumyl peroxide, 2,5-dimethyl-di-(tert-butylperoxy) hexane, and 1,1-di-(tert-butylperoxy)-trimethylcyclohexane. Both 2,5-dimethyl-di-(tert-butylperoxy) hexane, and 1,1-di-(tert-butylperoxy) trimethylcyclohexane are particularly useful and specific as free radical cure initiators for vinyl silicone heat cured rubbers.

High energy radiation, either as gamma rays or as an electron beam, can also effect curing. This type of cure causes a wide variety of bonds to be broken, thus crosslinks occur between a variety of different atomic centers as the radicals created by the high energy recombine to form new chemical bonds.

Other components that may be included in a silicone polymer formulation are additive materials that impart specific performance features to the finished cured polymer composition and include mold release agents, oxides of zinc, magnesium, copper, iron, aluminum, titanium, or cerium, ceric hydroxide, and the various metal salts of long chain fatty acids such as the metal octoates. Reinforcing fillers, and extending fillers such as precipitated silica, finely divided quartz, mica, alumina, titania, and the like are a necessary component in silicone rubber formulations, for without their addition the finished cured polymer possesses extremely poor mechanical and physical characteristics.

In general, silicone gum rubber and liquid silicone rubber compositions are prepared as follows: A cyclic siloxane such as octamethylcyclotetrasiloxane (D₄) is reacted with tetramethyldivinylsiloxane or a higher molecular weight divinylsiloxane analog in the presence of base (e.g. NH₄OH, KOH, or tetramethylammonium hydroxide), heat, and a catalyst (e.g. potassium silanolate) to yield a vinyl end-capped polymer. After equilibration, the temperature is raised in order to stop the polymerization and a vacuum is applied in order to remove equilibrated cyclic species, as well as low molecular weight oligomers. To the gum polysiloxane material, a filler such as silica is added along with a wetting agent such as hexamethyldisilazane, or an OH end-blocked polymer, and the base is blended to a fine consistency. The polymer base is screened to remove particulate matter and gels and the material is divided into an A & B component for formulation into the final two part curing system. The A-side is typically formulated with catalyst (Pt-based) and the B-side is formulated to include an inhibitor and cross linker. Upon combination of A with B, for example using a milling machine a vulcanizing mixture is created that cures upon the addition of heat.

When the B component, as described above, is combined with a peroxide catalyst and heated, a final cured rubber with excellent properties can be obtained. In the presence of unsaturated functional groups, as can be found in some organic polymers such as styrene-butadiene rubber, reactive blends where the organic polymer and silicone polymers link together can be formed.

Acetoxy-curing silicone rubber systems may also be used. These are typically prepared as follows: An OH end-blocked polymer is prepared by the reaction of a cyclic siloxane, e.g., D₄, in the presence of acid or base catalyst and the reaction is terminated by the addition of water. The resulting OH end-blocked material is blended with a filler material such as silica in combination with a wetting agent hexamethyldisilazane. The base (OH-terminated) material is heated under vacuum in order to remove residual cyclic starting materials and water. The base is formulated with methyltriacetoxysilane and a tin catalyst to yield a methyl diacetoxy end-blocked polymer. This material, when exposed to moisture, reacts to chain extend and cross-link to final cure.

Heat cured or heat-curing high consistency silicone rubbers (HCR) are one type of silicone polymer based on silicone polymer gums of varying molecular weights. These gums, along with fillers and additives, are mixed in dough mixers, Banbury type mixers or sigma bladed mixers to produce the siloxane polymer formulation. Curing catalysts and inhibitors are added on water-cooled rubber mills, to avoid premature heat cure, which can sometimes be used for the entire formulation in small-scale processes as well as to avoid contamination of the mixer. A high consistency rubber composition according to the present invention typically includes these fillers, additives, curing catalysts and inhibitors. The properties of heat cured silicone rubbers vary with the nature of the silicone gum and the various additives as well as their respective proportions. In addition, properties also vary according to procedures used to compound the rubber. For example, properties of a heat cured silicone rubber may therefore vary as a function of the thoroughness of the mixing and the degree of wetting of the filler by the gum. All other factors being equal, a hydrophilic filler as opposed to a hydrophobic filler will impart significantly different properties to a finished rubber. Further, properties of heat cured rubbers may change with time if the cure is not taken to completion. In order to avoid changes in the properties of a heat-cured rubber over time, these formulations are typically post-cured at a higher temperature to complete the cure. Heat cured silicone rubbers are described in more detail in U.S. Pat. Nos. 5,610,213 and 5,623,028, which are incorporated herein by reference.

Liquid silicone rubbers (LSR), including liquid injection moldable (LIM) silicone rubbers are another type of silicone polymer that may be used as a component of the blend compositions of the present invention. These are essentially the same as HCR gums except that they are of lower molecular weight. LSR compositions are typically provided as two components that are mixed immediately prior to use. Both components contain alkenyl/vinyl polymers, fillers, and in some cases resins. The first component contains a platinum catalyst while the second component contains a hydride crosslinker cure inhibitor. The two components are mixed immediately prior to use in the injection molding apparatus. In addition to providing a so-called formulation pot-life, the inhibitor must prevent curing of the curable composition until the mold is completely filled. Once the mold is completely filled, the inhibitor must then allow for a rapid cure of the vulcanizable composition in order to ensure a short cycle time. LIM silicone rubbers are described in more detail in U.S. Pat. No. 5,998,516, which is incorporated herein by reference. Curable liquid silicone rubbers (LSR) are particularly useful for the injection molding of intricate silicone rubber parts. In some cases, LSR compositions may offer advantages over conventional curable high-consistency silicone rubber compositions, such as faster mold cycling times and less deflashing of molded components. Generally, LSR compositions are considered to be those curable silicone compositions which can be pumped by conventional pumping apparatuses. Curable LSR compositions usually comprise a polydiorganosiloxane mixture (LSRs) having a viscosity within a range of about 0.03 to 100 Pa.s at 25 degree C.; silica reinforcing fillers, and other additives and processing aids may also be included.

Fluorosilicone heat cured elastomeric (HCE) are another type of silicone polymer that may be used as a component of the blend compositions of the present invention. These compositions are used in applications requiring chemical resistance, particularly, in automotive applications as gaskets, o-rings and diaphragms. Fluorosilicone HCE compositions are described in U.S. Pat. No. 5,916,937, which is incorporated herein by reference.

Organic polymers that are suitable for use in the blend composition of the present invention are derived from the polymerization of at least one olefin monomer. Olefin monomers include monoolefins, such as -olefins and strained ring olefins, and conjugated diolefin monomers. -Olefins are C₂₋₁₀ alkenes having ethylenic unsaturation in the - or 1-position, such as ethylene, propylene, butylene, and isobutylene. Suitable -olefins include, for example, -olefins containing from 3 to about 20, preferably from 3 to about 12, more preferably from 3 to about 8 carbon atoms. Particularly suitable are ethylene, propylene, butene-1, 4-methyl-1-pentene, 1-hexene or 1-octene or ethylene, alone, or in combination with one or more of propylene, 1-butene, 4-methyl-1-pentene, 1-hexene or 1-octene. Strained ring olefins are isomeric vinyl-ring substituted derivatives of cyclohexene and substituted cyclohexenes, norbomene and C₁₋₁₀ alkyl or C₆₋₁₀ aryl substituted norbomenes, including 1-, 3-, and 4-vinylcyclohexene, norbomene and 5-ethylidene-2-norbornene. Suitable conjugated diolefin monomers include 1,3-butadiene, 2,3-dimethyl-1, 3-butadiene, 2-phenyl-1,3-butadiene, 2-ethyl-1,3-butadiene, isoprene, 1,3-pentadiene, 2-methyl-1,3-pentadiene, 2,3-dimethyl-1,3-pentadiene, 3-methyl-1,3-pentadiene, 4-methyl-1,3-pentadiene, 1,3-hexadiene, 2,4-hexadiene, and 4,5-diethyl-1,3-octadiene. Copolymers derived from conjugated diolefins, for example, butadiene and isoprene copolymers, may contain residual unsaturation. These may be hydrogenated, or reduced, prior to use, if desired.

One or more vinyl-substituted aromatic monomer may be copolymerized with at least one olefin monomer to form organic polymers suitable for use in the blend compositions of the present invention. Examples of suitable vinyl-substituted aromatic monomers include styrene, α-methylstyrene, the lower alkyl (C₁-C₄)- or phenyl-ring substituted derivatives of styrene, such as for example, ortho-, meta-, and para-methylstyrene, the ring halogenated styrenes, para-vinyl toluene, 3,5-diethylstyrene, 4-ethylstyrene, 4-propylstyrene, 3,5-diethylstyrene, 2,4,6-trimethylstyrene, 4-dodecylstyrene, 2,3,4,5-tetraethylstyrene, 3-methyl-5-normal-hexylstyrene, 4-phenylstyrene, 2-ethyl-4-benzylstyrene, 3,5-diphenylstyrene, 1-vinylnaphthalene, 3-ethyl-1-vinylnaphthalene, 6-isopropyl-1-vinylnaphthalene, 6-cyclohexyl-1-vinylnapthalene, and 7-dodecyl-2-vinylnaphthalene. Styrene is particularly preferred. The organic polymer may also contain residues derived from other comonomers, for example, acrylate and/or methacrylate monomers, in addition to, or in place of, vinyl-substituted aromatic monomers.

The organic polymer may be a random copolymer, a block or graft copolymer, or a mixture thereof. In particular, the organic polymer may be a styrene-ethylene random copolymer, a butadiene rubber, a styrene-butadiene rubber (SBR), a styrene-butadiene-styrene block copolymer, a hydrogenated styrene-butadiene block copolymer, a hydrogenated styrene-butadiene-styrene block copolymer (styrene ethylene butylene styrene block copolymer (SEBS)), styrene-isobutylene-styrene (SIBS), a styrene isoprene rubber, a styrene isoprene butadiene rubber, a styrene-isoprene block copolymer, a styrene-isoprene-styrene block copolymer, a hydrogenated styrene-isoprene block copolymer, a styrene-isoprene-styrene block copolymer (SIS), a hydrogenated styrene-isoprene-styrene block copolymer (styrene-ethylene-propylene-styrene (SEPS)), a natural rubber, a chloroprene rubber, a butyl rubber, a polyisoprene rubber, a polychloroprene rubber, or a mixture thereof. Other rubbery copolymers that may be used include acrylonitrile-butadiene rubbers (NBR), acrylonitrile-butadiene-styrene polymers (ABS) polysulfide rubbers, acrylic elastomers, urethane rubbers, ethylene propylene rubbers, nitrile elastomers, ethylene acrylic elastomers, ethylene vinyl acetate copolymers, and mixtures thereof. Of these, styrene butadiene rubbers, hydrogenated styrene-butadiene-styrene block copolymers (styrene ethylene butylene styrene block copolymer (SEBS)), styrene-isobutylene-styrene (SIBS), styrene-isoprene-styrene block copolymers (SIPS), styrene-ethylene-ethylene-propylene-styrene copolymers (SEEPS), and hydrogenated styrene-isoprene-styrene block copolymers (styrene-ethylene-propylene-styrene (SEPS)) are preferred. These (SBR, SEBS, SIPS, and SEPS) may be obtained from Kraton Polymers, Houston, Tex., SEBS, SEPS and SEEPS may be obtained from Kuraray America Inc., New York, N.Y. as SEPTON® polymers.

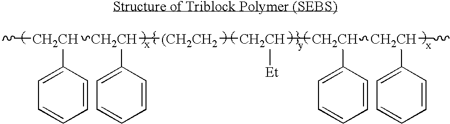

Molecular weight and glass transition temperature of the organic polymer can be varied in order to alter the final material's properties. It may be desirable, in some cases, to limit Shore hardness to the range between 40A and 75D. The organic polymer may also be formulated to include a plasticizer, such as mineral oil.

Vinyl-functional silicone rubbers may be co-vulcanizable with styrene-diene copolymers and even partially with hydrogenated styrene-diene copolymers, given that a percentage of the original double bonds survive the hydrogenation process. Styrene-ethylene copolymers on the other hand, ethylene, should not have any unsaturation remaining in the molecular structure after the polymerization. This may make these materials ideal for subsequent removal of the styrene-ethylene polymer to yield a porous silicone. In general, acetoxy-functional silicone rubbers, which are crosslinked by a condensation reaction in the presence of a condensation catalyst such as metal salts of organic acids, cannot be co-vulcanized with organic polymers in a polymer blend due to remoteness in the mechanisms of their crosslink-forming reactions, although this lack does not necessarily prevent formation of a cured blend composition having superior properties.

The blending proportion of the silicone polymer with the organic polymer is such that the blend composition contains from 50 to 99 parts by weight of the former and from 50 to 1 parts by weight of the latter, preferably, from 75 to 99 parts by weight of the former and from 25 to 1 parts by weight of the latter, and more preferably, from 90 to 99 parts by weight of the former and from 1 to 10 parts by weight of the latter. When the amount of the organic polymer component, particularly with a styrene-diene copolymer, is 5 parts, or less, by weight, the dispersion within the organopolysiloxane matrix is uniform and the blend approaches what would be considered a nanocomposite. In general the blends may be referred to as incompatible as they were white/opaque and apparently phase-separated. Cryogenic fracture of the material and subsequent evaluation of the fracture interface by SEM revealed the rubber additive as spherical domains approximately 0.5-2 microns in diameter; approaching what would be considered a nanocomposite (0.5 microns or 500 nm). The low energy spherical nature of the additive (organic polymer) domains provides substantiation for partial miscibility of the organic polymer in the silicone matrix.

As the organic polymer content is increased, it may be more difficult to maintain uniformity of the blend. This can result in diminished material properties. This is why the upper limit of 50% by weight, more preferably 25%, and most preferably <10% by weight is laid in the amount of the organic polymer.

Control over the distribution of polymer species in a blend can have a dramatic effect upon the final properties of the blend. For example, the minor component may act as a (particle) boundary thus imparting improved properties as with metals. Furthermore, if the cure mechanism and/or crosslinking mechanisms are the same for two or more polymers, the polymers may intercross link with each other during final cure. The result can be a polymer network that is homogeneous in each reactant or a heterogeneous blend in which the phases are bound through an interphone. Polymers with different miscibility's, physical, and/or chemical properties can be blended in a controlled fashion in order to produce an ordered polymer blend with improved physical, mechanical and possibly chemical properties. If the polymers being blended are too immiscible, the resulting blend may possess coarse irregular domains of various sizes and the cured blend may be unstable. In such cases, the interface is sharp and weak, yielding poor properties and incompatibility. When a two-phase system possesses good properties, it is typically the result of partial miscibility of the phases, covalent bonding, and interfacial tension and adhesion. Such blends are said to be compatible, and when the polymer blend has a commercial application attributable to its improved properties, it is said to possess practical compatibility. On the other hand, immiscibility, lack of covalent bonding or weak interfacial tension and/or adhesion is associated with a thin, sharp interface and steep property gradients, and as such do not possess desirable properties.

Treatment of vulcanized blends prepared using hydrogenated styrene polymers, or other polymers without residual unsaturation such as styrene ethylene copolymers, may allow for the facile removal of the organic polymer constituent using solvent extraction. This provides a material in which the pore size is controlled by the size of the organic polymer domain. Thus, extraction of the organic polymer component, in a non-reactive blend, can result in a microporous material with the pores ideally suited for cell infiltration and tissue ingrowth (diameter ˜20-50 micron). For example, a calendared sheet of silicone-organic polymer blend can be rendered porous for use in abdominal surgical procedures, or a molded component such as for use in a prosthetic chin, cheek, finger joint or other implantable configuration can be rendered with pores appropriate for tissue integration.

Method of Preparing Blends

The blend composition of the present invention is prepared in a straightforward manner by blending the above-mentioned components in a temperature-controlled sigma blade mixer with vacuum degassing capability. In the preparation of these blends, a silicone gumstock/lSR (base including silica) absent any cross-linking agent, catalyst or inhibitor is placed into the mixer and softened. Separately, an organic polymer is dissolved into a minimal amount of a solvent that is compatible with, or is a co-solvent for, the silicone rubber gum (e.g., hexane, heptanes, toluene, xylene, or THF). After the organic polymer solution/lacquer is added to the mixer containing the silicone gumstock/LSR, the mixer is closed and blending is initiated. The mixing of this viscous fluid blend creates significant heat resulting in the reflux of the co-solvent. The blend takes on an opaque white color indicating a multiphase system. When the blend is uniform in nature, vacuum is applied to the mixer and the solvent is removed. Following solvent removal, the mixer is stopped and the blend is allowed to cool. The cool blend is divided into two equal amounts of material and formulated into A and B components for two part cure systems (gum or LSR). This process works for acetoxy curing systems as well.

A more preferable way of preparing blends of this type involves the addition of the organic polymer lacquer during the formulation of the silicone rubber. Thus, at the point during the formulation/synthesis of the silicone (gum, LSR, or OH end-blocked polymers for acetoxy cure), just prior to the addition of heat to remove cyclic precursor materials, the rubber lacquer is added and blending is initiated until the formation of a uniform (white) mixture. Heat is subsequently applied and the cyclic precursors are removed along with the solvent.

Blends involving diphenyl or mixed diphenyl-dimethyl siloxanes are prepared in much the same way. Because these siloxane materials are supplied as solutions used for dip coating (i.e. over mandrels), the organic polymer additive will be co-solubilized in a solvent such as xylene.

The blend composition thus prepared is shaped and vulcanized into finished vulcanizates of desired shapes by a conventional fabrication means such as press molding, extrusion, calendaring, dip coating and the like. Thus finished articles can find very wide applications owing to their excellent rubber-like elasticity as well as superior heat resistance, oil resistance, solvent resistance, electric properties, mechanical properties and other properties. Particular medical applications include finger joints, balloons, valves, o-rings, tubing, sheeting, membranes and reconstructive/cosmetic (soft tissue) devices/constructs.

### EXAMPLES

Following are examples used to illustrate the elastomer compositions of the present invention in further detail.

HCR-1:

A vinyl-rich high consistency organopolysiloxane base silicone material (Nusil Technologies MED 4770) was combined with a styrene-ethylene-butylene-styrene triblock copolymer (Shell Kraton G1650, 493 grams) using the above-described blending technique to yield a total of 12.31 Kg of blend. The blend was divided into two parts; part A (6.25 Kg) was formulated with catalyst (0.0923 PPH, 5.8 grams vinyl-dipt) and part B (6.06 Kg) was formulated to include a cross-linking agent (10/50 XL, 3.0 PPH, 181.9 grams) and inhibitor (etch, 0.040 PPH, 2.4 grams).

HCR-2:

A vinyl-rich high consistency organopolysiloxane base silicone material (Nusil Technologies MED 4770), was combined with a styrene-butadiene copolymer (Shell Kraton D1102, 4% by weight, 6.35 Kg) using the above described blending technique and the blend was divided into two parts. Part A was formulated with catalyst (0.0923 PPH, 5.9 grams vinyl-dipt) and Part B (6.15 Kg) was formulated to include a cross-linking agent (10/50 XL, 3.3 PPH, 202.9 grams) and inhibitor (etch, 0.040 PPH, 2.5 grams).

HCR-3:

A vinyl-rich high consistency organopolysiloxane base silicone material (Nusil Technologies MED 4770), was combined with a styrene-isoprene-styrene copolymer (SIS) (Shell Kraton D1107P, 4% by weight, 6.5 Kg) using the above described blending technique and the blend was divided into two parts. Part A was formulated with catalyst (0.0923 PPH, 6.0 grams vinyl-dipt) and Part B (6.3 Kg) was formulated to include a cross-linking agent (10/50 XL, 3.3 PPH, 207.7 grams) and inhibitor (etch, 0.040 PPH, 2.5 grams).

PCR-1:

A vinyl-rich high consistency organopolysiloxane base silicone material (Nusil Technologies MED 4770), was combined with a styrene-ethylene-butylene-styrene triblock copolymer (Shell Kraton G1650, 493 grams) using the above-described blending technique to yield a total of 12.31 Kg of blend. The blend was divided into two parts; part A (6.25 Kg) was formulated with catalyst (0.0923 PPH, 5.8 grams vinyl-dipt) and part B (6.06 Kg) was formulated to include a cross-linking agent (10/50 XL, 3.0 PPH, 181.9 grams) and inhibitor (etch, 0.040 PPH, 2.4 grams).

A 500 g sample of part B above was removed and placed onto a 2-roll mill and 3.75 g 2,5 bis (tert-butyl peroxy) 2,5-dimethyl hexane (0.75 PPH, Lupersol 101) was compounded into the material. The material was transfer molded into slabs and cured by heating for 10 minutes @ 177° C.

PCR-2:

A vinyl-rich high consistency organopolysiloxane base silicone material (Nusil Technologies MED 4770), was combined with a styrene-butadiene copolymer (Shell Kraton D1102, 4% by weight, 6.35 Kg) using the above described blending technique and the blend was divided into two parts. Part A was formulated with catalyst (0.0923 PPH, 5.9 grams vinyl-dipt) and Part B (6.15 Kg) was formulated to include a cross-linking agent (10/50 XL, 3.3 PPH, 202.9 grams) and inhibitor (etch, 0.040 PPH, 2.5 grams).

A 525 g sample of part B above was removed and placed onto a 2-roll mill and 3.94 g 2,5 bis (tert-butyl peroxy) 2,5-dimethyl hexane (0.75 PPH, Lupersol 101) was compounded into the material. The material was transfer molded into slabs and cured by heating for 10 minutes@177° C.

PCR-3:

A vinyl-rich high consistency organopolysiloxane base silicone material (Nusil Technologies MED 4770), was combined with a styrene-isoprene copolymer (Shell Kraton D1107P, 4% by weight, 6.5 Kg) using the above described blending technique and the blend was divided into two parts. Part A was formulated with catalyst (0.0923 PPH, 6.0 grams vinyl-dipt) and Part B (6.3 Kg) was formulated to include a cross-linking agent (10/50 XL, 3.3 PPH, 207.7 grams) and inhibitor (etch, 0.040 PPH, 2.5 grams).

A 510 g sample of part B above was removed and placed onto a 2-roll mill and 3.83 g 2,5 bis (tert-butyl peroxy) 2,5-dimethyl hexane (0.75 PPH, Lupersol 101) was compounded into the material. The material was transfer molded into slabs and cured by heating for 10 minutes@177° C.

DPR-1:

A 35% solids xylene dispersion of organopolysiloxane composed of 85 mole % of dimethylsiloxane units and 15% diphenylsiloxane units (Nusil MED 10-6600, 100 g A & 100 g B) were combined with 2.9 g styrene-ethylene-butylene-styrene copolymer (Shell Kraton G1650, 4% solids) and the mixture allowed to stand until the organic polymer dissolved. The lacquer was poured into a glass crystallization dish and the solvent was allowed to evaporate over a 4-hour period in a hood. The film was dried in a 100° C. oven for a 3-hour period and the material was heated to final cured in an oven at 150° C. for one additional hour to yield an opaque/transparent film

DPR-2:

A 35% solids xylene dispersion of organopolysiloxane composed of 85 mole % of dimethylsiloxane units and 15% diphenylsiloxane units (Nusil MED 10-6600, 100 g A & 100 g B) were combined with 2.9 g Styrene-butadiene copolymer (Shell Kraton D1102, 4% solids) and the mixture allowed to stand until the organic polymer dissolved. The lacquer was poured into a glass crystallization dish and the solvent was allowed to evaporate over a 4-hour period in a hood. The film was dried in a 100° C. oven for a 3-hour period and the material was heated to final cured in an oven at 150° C. for 1 additional hour to yield an opaque/transparent film.

DPR-3:

A 35% solids xylene dispersion of organopolysiloxane composed of 85 mole % of dimethylsiloxane units and 15% diphenylsiloxane units (Nusil MED 10-6600, 100 g A & 100 g B) were combined with 2.9 g Styrene-isoprene-styrene copolymer (Shell Kraton D1107P, 4% solids) and the mixture allowed to stand until the organic polymer dissolved. The lacquer was poured into a glass crystallization dish and the solvent was allowed to evaporate over a 4-hour period in a hood. The film was dried in a 100° C. oven for a 3-hour period and the material was heated to final cured in an oven at 150° C. for 1 additional hour to yield an opaque/transparent film.

According to the formulations as given in above and in Table 1, a silicone polymer, a styrene copolymer, filler, crosslinker, inhibitor and vulcanizing agent were blended uniformly into elastomer compositions.

| Formu- | | | | | | |
|---|---|---|---|---|---|---|
| lation | Silicone | Additive (grams) | Crosslinker | Inhibitor | Catalyst | Cure Conditions |
| Control | Nusil MED 4770 parts | 0 | Preformulated | Preformulated | Preformulated | 10 minutes @ 177° C. |
| | A & B | | | | | |
| HCR-1a | Nusil MED 4770 base, | Shell Kraton G1650 | 181.9 g trimethyl | 2.4 g | 5.8 g platinum vinyl | 10 minutes @ 177° C. |
| | 11,817 grams | (styrene-ethylene- | terminated - | 2-methyl-3- | siloxane complex | |
| | | butylene-styrene | dimethyl/methyl | hydroxy butyne | | |
| | | triblock), 493 grams | hydrogen copolysiloxane | | | |
| HCR-2a | Nusil MED 4770 base, | Shell Kraton D1103 | 202.9 g trimethyl | 2.5 g | 5.9 g platinum vinyl | 10 minutes @ 177° C. |
| | 12,000 grams | (styrene-butadiene | terminated - | 2-methyl-3- | siloxane complex | |
| | | rubber), 500 grams | dimethyl/methyl | hydroxy butyne | | |
| | | | hydrogen copolysiloxane | | | |
| HCR-3a | Nusil MED 4770 base, | Shell Kraton D1107, | 207.7 g trimethyl | 2.5 g | 6.0 g platinum vinyl | 10 minutes @ 177° C. |
| | 12,288 grams | (styrene-isoprene | terminated - | 2-methyl-3- | siloxane complex | |
| | | copolymer), 512 grams | dimethyl/methyl | hydroxy butyne | | |
| | | | hydrogen copolysiloxane | | | |
| HCR-1b | Nusil MED 4770 base, | Shell Kraton G1650 | 15.0 g trimethyl | 0.2 g | 0.48 g platinum vinyl | 10 minutes @ 177° C. |
| | 980 grams | (SEBS), 245 grams | terminated - | 2-methyl-3- | siloxane complex | |
| | | | dimethyl/methyl | hydroxy butyne | | |
| | | | hydrogen copolysiloxane | | | |
| HCR-2b | Nusil MED 4770 base, | Shell Kraton D1103 | 14.8 g trimethyl | 0.2 g | 0.47 g platinum vinyl | 10 minutes @ 177° C. |
| | 962 grams | (SBR), 240.5 grams | terminated - | 2-methyl-3- | siloxane complex | |
| | | | dimethyl/methyl | hydroxy butyne | | |
| | | | hydrogen copolysiloxane | | | |
| HCR-3b | Nusil MED 4770 base, | Shell Kraton D1107, | 14.0 g trimethyl | 0.2 g | 0.45 g platinum vinyl | 10 minutes @ 177° C. |
| | 910 grams | (SIPS), 227 grams | terminated - | 2-methyl-3- | siloxane complex | |
| | | | dimethyl/methyl | hydroxy butyne | | |
| | | | hydrogen copolysiloxane | | | |
| PCR-1 | 500 grams part B from | 20.8 g Kraton G1652 | 17.3 g trimethyl | N/A | 3.75 g 2,5 bis(tert- | 10 minutes @ 177° C. |
| | HCR-1 | | terminated - | | butyl peroxy) 2,5- | |
| | | | dimethyl/methyl | | dimethyl hexane | |
| | | | hydrogen copolysiloxane | | (Lupersol 101) | |
| PCR-2 | 525 g part B from | 21.9 g Kraton D1103 | 18.2 g trimethyl | N/A | 3.94 g 2,5 bis (tert- | 10 minutes @ 177° C. |
| | HCR-2 | | terminated - | | butyl peroxy) 2,5- | |
| | | | dimethyl/methyl | | dimethyl hexane | |
| | | | hydrogen copolysiloxane | | (Lupersol 101) | |
| PCR-3 | 510 g part B from | 21.3 g Kraton D1107 | 17.7 g trimethyl | N/A | 3.83 g 2,5 bis (tert- | 10 minutes @ 177° C. |
| | HCR-3 | | terminated - | | butyl peroxy) 2,5- | |
| | | | dimethyl/methyl | | dimethyl hexane | |
| | | | hydrogen copolysiloxane | | (Lupersol 101) | |
| DPR-1 | Nusil MED 10-6600, | 2.9 g Kraton G1652 | Preformulated | Preformulated | Platinum | Evaporate xylenes to |
| | 100 grams 35% solids | | | | | yield a film, 45 |
| | (50 g part A/50 g part | | | | | minutes @ 75° C., |
| | B) in xylenes | | | | | 2.25 hours @ 150° C. |
| DPR-2 | Nusil MED 10-6600, | 2.9 g Kraton D1103 | Preformulated | Preformulated | Platinum | Evaporate xylenes to |
| | 100 grams 35% solids | | | | | yield a film, 45 |
| | (50 g part A/50 g part | | | | | minutes @ 75° C., |
| | B) in xylenes | | | | | 2.25 hours @ 150° C. |
| DPR-3 | Nusil MED 10-6600, | 2.9 g Kraton D1107 | Preformulated | Preformulated | Platinum | Evaporate xylenes to |
| | 100 grams 35% solids | | | | | yield a film, 45 |
| | (50 g part A/50 g part | | | | | minutes @ 75° C., |
| | B) in xylenes | | | | | 2.25 hours @ 150° C. |

HCR = HIGH CONSISTENCY RUBBER
PCR = PEROXIDE CURED RUBBER
DPR = DIPHENYL RUBBER
MED 10-6600 - 2 part platinum curing diphenyl - dimethyl siloxane rubber
MED 4770 - 2 part platinum curing vinyl siloxane high consistency rubber (70 shore A hardness)

Each of the blend compositions was fabricated into specimens and tested as follows:

Taber Abrasion: D4060 (Weight Loss)

Scope:

Taber abrasion is a test to determine a plastic's resistance to abrasion. Resistance to abrasion is defined as the ability of a material to withstand mechanical action such as rubbing scrapping, or erosion. Abrasion can be difficult to compare but haze variation or weight loss are often evaluated.

Test Procedure:

The haze or original weight of test specimen is measured. The test specimen is then placed on the abrasion tester. A 250, 500, or 1000-gram load is placed on top of the abrader wheel and allowed to spin for a specified number of revolutions. Different abrading wheels are specified. A haze measurement or final weight is taken. The load and wheel can be adjusted for softer and harder materials.

Specimen Size:

Either a 4-inch diameter disk or a 4 sq. inch plate is used. A ½ inch diameter whole in center is required.

Data:

Results are expressed by changes in weight loss in mg/# of cycles.

Equipment Used:

Taber Abrasion Apparatus; Abrasion Wheels; Haze meter; Balance

Compression Set: ASTM D395 B

Scope:

Compression set testing is used to determine the ability of elastomeric materials to maintain elastic properties after prolonged compressive stress. The test measures the somewhat permanent deformation of the specimen after it has been exposed to compressive stress for a set time period. This test is particularly useful for applications in which elastomers would be in a constant pressure/release state.

Test Procedure:

The thickness of the original specimen is measured. The specimen is then placed between spacers and in the compression device. The specimen is compressed to 25% of its original height, using spacers to accurately measure the compression. Within two hours of assembly, the compression device is placed in an oven at a specified temperature for the suggested time periods of 22 hours and 70 hours. After removing the sample from the oven, the specimen is allowed to cool for 30 minutes before measuring the final thickness.

Specimen Size:

There are 2 cylindrical disk specimen sizes:

Type 1: Thickness is 12.5 mm+/−0.5 mm Type 2: Thickness is 6.0 mm+/−0.2 mm

Diameter is 29.0 mm+/−0.5 mm Diameter is 13.0 mm+/−0.2 mm

Data:

Compression set is expressed as a percentage of the original deflection.

CB=[(to−ti)/(to−tn)]×100

CB=Compression set

to=Original thickness of the specimen

ti=Final thickness of the specimen

tn=thickness of the space bars used

Equipment Used:

Compression set device consisting of spacers, compression plates, nuts and bolts, and Measuring devices.

Tensile: ASTM D412

Scope:

Tensile tests measure the force required to break a specimen and the extent to which the specimen stretches or elongates to that breaking point. The data is often used to specify material, to design parts to withstand application forces and as a quality control check of materials.

Test Procedure:

Place specimens in the grips of the Instron at a specified gage length and pull until failure. The testing speed is determined by the material specification. An extensometer can also be attached to test specimen to determine elongation and tensile modulus.

Specimen Size:

Dumbbell or ring specimen is required. It can be either injection molded or cut from a flat sheet.

Data:

The following calculations are the most common results given:

1. tensile strength (at yield and at break)

2. tensile modulus (for elastomers, this is stress at a given % strain)

3. strain

4. elongation and percent elongation at yield

5. elongation and percent elongation at break

6. elongation (tension) set is a separate test where samples measured, stretched/elongated to a predefined point, and allowed to sit for 10 minutes at which point the tension is released and the samples are re-measured.

There are additional calculations and a variety of units (lbs, psi, MPa, kN, etc.)

Equipment Used:

Instron Universal Tester; Pneumatic Grips; 1000% Extensometer.

Tear Resistance: ASTM D1004

Scope:

Tear resistance measures the ultimate force required to tear film or sheet. It is often used for quality control checks or for material comparison where tear failures are possible.

Test Procedure:

The average thickness of the specimen is measured. The specimen is then placed in the grips of the testing machine and pulled at a rate of 20 in. per minute until rupture.

Specimen Size:

The specimen is die cut to the appropriate shape from a sheet. The shape of the specimen is designed to create a tear when the specimen is pulled in tension. Die C specimens are commonly used.

Data:

The resistance is measured in Newtons.

Equipment Used:

Instron Universal tester; Air grips or Roller grips; Die cutters

The results obtained in the determination of the properties of the blend compositions are set out in Tables 2 and 3.

TABLE 2
Abrasion Testing
(Taber B H22 Wheel - 3000 cycles, ASTM D3389-87)

| Material | Mass loss per revolution (mg/rev.) |
|---|---|
| Med-4770 (control) | 0.154 |
| HCR-1 | 0.098 |
| HCR-2 | 0.099 |
| HCR-3 | 0.143 |

It can be seen from Table 2 that blending the Med-4770 silicone rubber with only 4% organic polymer increased abrasion resistance.

TABLE 3
Mechanical Properties

| | Durometer | Compression | Tension |
|---|---|---|---|
| Material | (Shore A) | Set | Set |
| MED-4770 (control) | 68 | 16 | 28 |
| HCR-1 | 67 | 7 | 13 |
| HCR-2 | 66 | 8 | 17 |
| HCR-3 | 55 | 6 | 20 |

The data shows that HCR-1 & -2 possess nearly the same Shore hardness but compression set and tension set have decreased remarkably. HCR-3 shows that the addition of the SIS drops the Shore hardness significantly while still decreasing compression and tension set. The addition of the organic polymer imparts improved elastic properties to the silicone.

In another experiment, blending of a xylene dispersion of a phenyl containing organopolysiloxane with a styrene containing elastomer yielded a material with an unexpected attribute of optical clarity. This is likely due to the improved solubilization of the aromatic styrene-containing organic polymer into the phenyl-functionalized silicone. This material was prepared to improve the abrasion resistance of implants such as for breast implants and balloons.

One of the unexpected properties that these blends possess is their lubricious surface relative to silicone rubber. Silicones generally stick together, or “block”, when in surface contact. This is a non-desirable attribute generally attributed to surface tension that is attributed to the surface energy of the materials and the oils/cyclics that “migrate” to the surfaces. In the extreme, blocking may be described as a “chemical bond” between two silicone surfaces that can only be undone by tearing the two apart. HCR-1, 2, and 3 and PCR-1, 2, 3 all demonstrated non-blocking characteristics that are likely attributed to additive polymer domains at the surface that change the surface energy characteristics providing “lubricity” relative to unmodified silicone. This attribute was present for platinum and peroxide cured rubbers.

What is claimed is:

1. A blend composition comprising
a. at least one silicone polymer; and
b. at least one organic polymer comprising residues derived from at least one olefin monomer;
with the proviso that the blend composition does not comprise a polyfunctional compatibilizer having an ethylenically unsaturated functional group and a group selected from hydroxy, alkoxy, carboxy, ester, amide, and halogen.

2. A blend composition according to claim 1, wherein said at least one organic polymer comprises an organic elastomer.

3. A blend composition according to claim 1, wherein said at least one organic polymer comprises residues derived from at least one monoolefin monomer.

4. A blend composition according to claim 1, wherein said at least one organic polymer comprises residues derived from at least one conjugated diolefin monomer.

5. A blend composition according to claim 1, wherein said at least one organic polymer additionally comprises residues derived from at least one vinyl-substituted aromatic monomer.

6. A blend composition according to claim 5, wherein said at least one vinyl-substituted aromatic monomer comprises styrene.

7. A blend composition according to claim 1, wherein said at least one organic polymer is selected from styrene ethylene copolymers, styrene butadiene rubbers, styrene-butadiene-styrene block copolymers, hydrogenated styrene-butadiene-styrene block copolymers, hydrogenated styrene-butadiene block copolymers, styrene-isobutylene-styrene, styrene isoprene rubbers, styrene isoprene butadiene rubbers, styrene-isoprene block copolymers, styrene-isoprene-styrene block copolymers, hydrogenated styrene-isoprene random copolymers, hydrogenated styrene-isoprene-styrene block copolymers, natural rubbers, synthetic poly(isoprene), poly(butadiene), poly(methylpentene), chloroprene, butyl rubbers.

8. A blend composition according to claim 1, wherein said at least one organic polymer is a styrene butadiene rubber.

9. A blend composition according to claim 1, wherein said at least one organic polymer is a styrene ethylene random copolymer.

10. A blend composition according to claim 1, wherein said at least one organic polymer is a styrene-isoprene-styrene block copolymer.

11. A blend composition according to claim 1, wherein said at least one organic polymer is a hydrogenated styrene-butadiene-styrene block copolymer.

12. A blend composition according to claim 1, wherein said at least one organic polymer is a styrene-ethylene-ethylene-propylene-styrene copolymer.

13. A blend composition according to claim 1, wherein said silicone polymer comprises a silicone gum.

14. A blend composition according to claim 1, wherein said silicone polymer comprises a high consistency silicone rubber composition.

15. A blend composition according to claim 1, wherein said silicone polymer comprises a liquid silicone rubber.

16. A blend composition according to claim 1, wherein said silicone polymer comprises a liquid silicone rubber composition.

17. A blend composition according to claim 1, wherein said silicone polymer comprises a vinyl-functional silicone.

18. A blend composition according to claim 1, wherein said silicone polymer comprises an acetoxy-functional silicone.

19. A blend composition according to claim 1, comprising
a. 50 to 99 parts by weight of at least one silicone polymer; and
b. 1 to 50 parts by weight of at least one organic polymer.

20. A blend composition according to claim 1, comprising
a. 75 to 99 parts by weight said at least one silicone polymer; and
b. 1 to 25 parts by weight said at least one organic polymer.

21. A blend composition according to claim 1, comprising
a. 90 to 99 parts by weight said at least one silicone polymer; and
b. 1 to 10 parts by weight said at least one organic polymer.

22. An article comprising a cured blend composition according to claim 1.
